(19) United States
(12) Patent Application Publication
(10) Pub. No.: US 2026/0267349 A1
(43) Pub. Date: Sep. 10, 2026

(54) VEHICLE CONTROL SYSTEM

(71) Applicant: TOYOTA JIDOSHA KABUSHIKI KAISHA, Toyota-shi (JP)

(72) Inventor: Kento IWAHORI, Nagoya-shi (JP)

(73) Assignee: TOYOTA JIDOSHA KABUSHIKI KAISHA, Toyota-shi (JP)

(21) Appl. No.: 19/529,355

(22) Filed: Feb. 4, 2026

(30) Foreign Application Priority Data
Feb. 14, 2025 (JP) 2025-022226

(51) Int. Cl. G05D 1/65; G05D 1/221; G05D 1/249; G05D 107/70; G05D 109/10; G05D 111/10; G06T 7/70

(52) U.S. Cl. CPC G05D 1/65; G05D 1/221; G05D 1/249; G06T 7/70; G05D 2107/70; G05D 2109/10; G05D 2111/10; G06T 2207/30196; G06T 2207/30252

(57) ABSTRACT

A vehicle control system according to the present disclosure includes a sensor configured to detect position information of a plurality of vehicles traveling, and a controller configured to control traveling of the vehicles based on the position information acquired from the sensor. The vehicle control system is configured such that the vehicles are caused to autonomously move at a predetermined interval on a work line while a worker moves to each of the vehicles to perform work. The controller is configured to reduce, in a case where a work delay occurs in any of the vehicles on the work line, speeds of the vehicles while the predetermined interval is maintained.

### CROSS-REFERENCE TO RELATED APPLICATION

This application claims priority to Japanese Patent Application No. 2025-022226 filed on Feb. 14, 2025. The disclosure of the above-identified application, including the specification, drawings, and claims, is incorporated by reference herein in its entirety.

### BACKGROUND

### 1. Technical Field

The present disclosure relates to a vehicle control system.

### 2. Description of Related Art

For example, as disclosed in Japanese Patent No. 7424535 (JP 7424535 B), in a case where a vehicle is manufactured, for example, a technology (autonomous transport technology) of causing the vehicle to autonomously move to be transported by autonomous control or remote control instead of transporting the vehicle by a conveyor is known.

### SUMMARY

For example, in a case of performing work on a work line, on which inspection, assembly, or the like is performed, while a plurality of vehicles is caused to autonomously move at a predetermined interval without using a belt conveyor, a worker for each of the vehicles needs to move together with the vehicle. Here, in a case where a delay in work occurs in a certain vehicle and the delay increases to a certain extent, all vehicles on the work line are stopped. Therefore, there is a problem that work efficiency is reduced.

The present disclosure has been made in view of such circumstances, and provides a vehicle control system capable of suppressing a decrease in work efficiency even in a case where a work delay occurs on a work line on which the vehicles are caused to autonomously move at the predetermined interval.

A vehicle control system according to the present disclosure includes:
a sensor configured to detect position information of a plurality of vehicles traveling; and
a controller configured to control traveling of the vehicles based on the position information acquired from the sensor, in which:
the vehicles are caused to autonomously move at a predetermined interval on a work line while a worker moves to each of the vehicles to perform work; and
the controller is configured to reduce, in a case where a work delay occurs in any of the vehicles on the work line, speeds of the vehicles while the predetermined interval is maintained.

In the vehicle control system according to the present disclosure, in a case where a work delay occurs in any of the vehicles on the work line, the speeds of the vehicles are reduced while the predetermined interval is maintained. Therefore, even in a case where the work delay occurs, all vehicles on the work line do not need to be stopped, and the decrease in work efficiency can be suppressed.

The present disclosure can provide a vehicle control system capable of suppressing a decrease in work efficiency even in a case where a work delay occurs on a work line on which a plurality of vehicles is caused to autonomously move at a predetermined interval.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a control system of a vehicle control system according to a first embodiment;

FIG. 2 is a side view schematically showing a work line on which a vehicle autonomously moves in the vehicle control system according to the first embodiment;

FIG. 3 is a side view schematically showing a work line on which a vehicle autonomously moves in a vehicle control system according to a modification of the first embodiment;

FIG. 4 is a diagram for describing traveling control of a vehicle;

FIG. 5 is a control block diagram for describing a traveling control example 1;

FIG. 6 is a flowchart for describing the traveling control example 1;

FIG. 7 is a control block diagram for describing a traveling control example 2; and

FIG. 8 is a flowchart for describing the traveling control example 2.

### DETAILED DESCRIPTION OF EMBODIMENTS

Hereinafter, specific embodiments of the disclosure will be described in detail with reference to the drawings. Note that, the embodiments of the disclosure are not limited to the following embodiments. Further, in order to clarify the description, the following description and drawings are appropriately simplified.

### First Embodiment

### Overview of Vehicle Control System

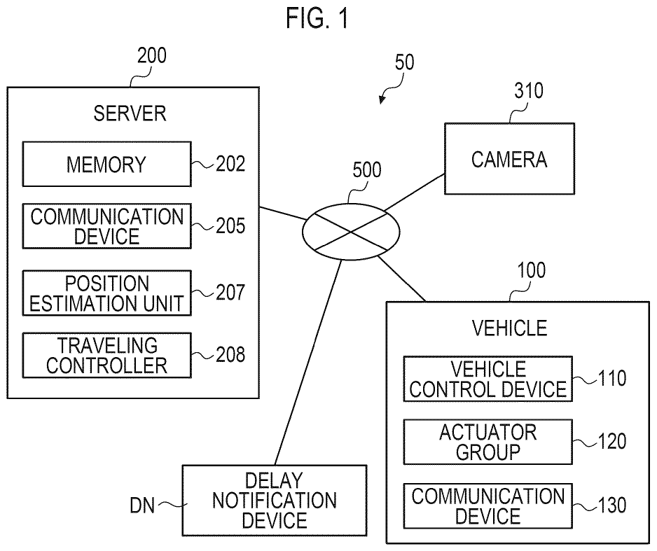

First, an overview of the vehicle control system according to the first embodiment will be described with reference to FIG. 1. FIG. 1 is a block diagram showing a control system of a vehicle control system according to the first embodiment. As shown in FIG. 1, a vehicle control system (referred to as a system) 50 includes a server 200, a camera 310, and a delay notification device DN, and controls traveling of a vehicle 100.

A vehicle control system 50 is applied to, for example, control of the vehicle 100 that autonomously drives on a work line in a vehicle manufacturing plant that manufactures the vehicle 100. Therefore, the vehicle 100 that is a control target is an autonomously moved vehicle that can autonomously drive during a manufacturing process. In other words, the vehicle 100 is a vehicle that can be moved by unmanned driving during the manufacturing process.

As shown in FIG. 1, the server 200 includes a memory 202, a communication device 205, a position estimation unit 207, and a traveling controller 208. The vehicle 100 includes a vehicle control device 110, an actuator group 120, and a communication device 130.

The server 200 may be configured by a single physical device or may be configured by a plurality of distributed devices.

The server 200 has a function as a controller that estimates a position of the vehicle 100 based on a captured image of the vehicle 100 received from the camera 310 and controls traveling of the vehicle 100 that is a control target.

In the server 200, the communication device 205 communicates with the camera 310 and the vehicle 100 via a network 500. The communication device 205 receives, for example, data, such as a captured image from the camera 310 and transmits information (vehicle control information) for controlling traveling of the vehicle 100 generated based on the image to the vehicle 100.

The position estimation unit 207 recognizes the vehicle 100 based on an image of the vehicle 100 captured by the camera 310 and estimates a position of the vehicle 100. Specifically, the communication device 205 receives data, such as a captured image from the camera 310, and the position estimation unit 207 analyzes the received captured image (that is, image analysis) to estimate the position of the vehicle 100.

The traveling controller 208 generates information (vehicle control information) for controlling traveling of the vehicle 100 based on the position of the vehicle 100 estimated by the position estimation unit 207.

The vehicle control information generated by the traveling controller 208 is transmitted to the vehicle 100 via the communication device 205. In the vehicle 100, the communication device 130 receives the vehicle control information transmitted from the server 200, and the vehicle control device 110 operates the actuator group 120 based on the received vehicle control information to cause the vehicle 100 to travel.

The camera 310 is one form of an external sensor 300 described below and images, for example, the vehicle 100 that travels on the work line from above. That is, the camera 310 functions as a sensor that detects position information of the traveling vehicle 100. The camera 310 has a communication function, and data, such as an image captured by the camera 310 is transmitted to the server 200 via the network 500.

The delay notification device DN is a device for a worker to perform notification of a work delay. The delay notification device DN has a communication function, and information indicating a degree of the work delay transmitted from the delay notification device DN is transmitted to the server 200 via the network 500.

In the present specification, the worker includes a work robot.

In the server 200, the communication device 205 receives information indicating the degree of the work delay from the delay notification device DN, and the traveling controller 208 reduces the speeds of a plurality of vehicles 100 while the predetermined interval is maintained based on the information. For example, the traveling controller 208 increases the amount of reduction in the speed of the vehicle 100 as the degree of the work delay increases.

Details of Work Line to which Vehicle Control System is Applied

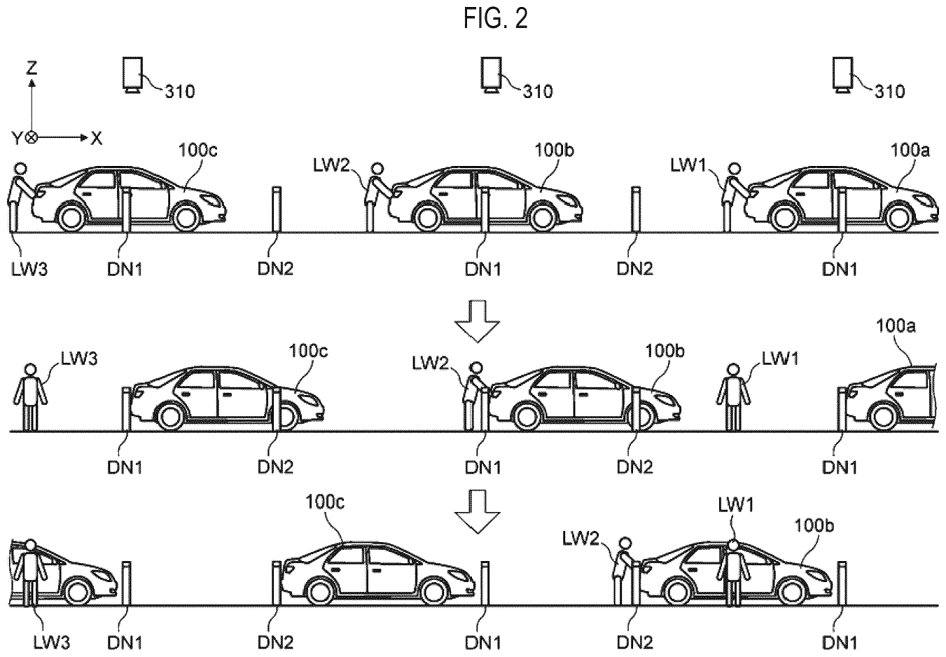

Next, details of the work line to which the vehicle control system according to the present embodiment is applied will be described with reference to FIG. 2. FIG. 2 is a side view schematically showing a work line on which a vehicle autonomously moves in the vehicle control system according to the first embodiment.

The right-handed XYZ orthogonal coordinate system shown in FIG. 2 is for convenience of description of positional relationships between components. In FIG. 2 and the like, for example, the positive direction of the Z-axis is a vertical upward direction and the XY plane is a horizontal plane, the directions being common between the drawings.

The work line shown in FIG. 2 extends in the X-axis direction, and a plurality of vehicles 100a, 100b, 100c, and 100d that is a target of the vehicle control system autonomously drives on the work line in the positive direction of the X-axis. That is, the vehicle 100 shown in FIG. 1 includes the vehicles 100a, 100b, 100c, and 100d shown in FIG. 2.

The work lines shown in the upper, middle, and lower parts of FIG. 2 indicate that time has elapsed from the upper part to the lower part. As shown in the upper part of FIG. 2, the camera 310 is arranged at predetermined intervals in the X-axis direction on the work line. The camera 310 is omitted in the middle and lower parts of FIG. 2.

First, in the work line shown in the upper part of FIG. 2, each of the workers LW1, LW2, and LW3 performs work while each of the workers LW1, LW2, and LW3 moves together with the autonomously moved vehicles 100a, 100b, and 100c. The work includes, for example, inspection or assembly. Here, each of the workers LW1, LW2, and LW3 performs work on the vehicles 100a, 100b, and 100c that autonomously drive in a predetermined assigned area on the work line.

In addition, as shown in the upper, middle, and lower parts of FIG. 2, two delay notification devices DN1 and DN2 are installed in each of the assigned areas of the workers LW1, LW2, and LW3 on the work line. The delay notification device DN shown in FIG. 1 includes the delay notification devices DN1 and DN2 shown in FIG. 2. The delay notification devices DN1 and DN2 are, for example, buttons provided at the side of the work line. A worker who reaches the delay notification devices DN1 and DN2 due to the work delay transmits information indicating the degree of the work delay to the server 200 via the network 500 by pressing the delay notification devices DN1 and DN2.

In a case where the buttons of the delay notification devices DN1 and DN2 are pressed and the information indicating the degree of the work delay is transmitted to the server 200, the traveling controller 208 of the server 200 reduces the speeds of the vehicles 100 while the predetermined interval is maintained. First, in a case where the button of the delay notification device DN1 is pressed, for example, the speeds of the vehicles 100 are reduced to ½. Further, in a case where the button of the delay notification device DN2 is pressed, for example, the speeds of the vehicles 100 are further reduced to ½ (that is, ¼ of the original speed). The reduction rate of the speed is merely an example and is appropriately set.

The delay notification devices DN1 and DN2 are not limited to the buttons and may be, for example, a touch panel. Alternatively, the delay notification devices DN1 and DN2 may be, for example, a human body sensor that detects a person by waving a hand. In addition, the number of delay notification devices installed in the assigned area of each worker is not limited to two, and may be one or three or more.

Next, in the work line shown in the middle part of FIG. 2, each of the workers LW1 and LW3 finishes the work on the vehicles 100a and 100c, and waits for the next vehicles 100b and 100d. On the other hand, the worker LW2 does not finish the work on the vehicle 100b, and a work delay occurs.

Here, in the middle part of FIG. 2, the worker LW2 reaches the delay notification device DN1, and thus presses the delay notification device DN1. Therefore, as described above, the traveling controller 208 of the server 200 reduces the speeds of the vehicles 100a, 100b, 100c, and 100d to ½ while the predetermined interval is maintained.

Next, in the work line shown in the lower part of FIG. 2, the workers LW1 and LW3 continue to wait for the next vehicles 100b and 100d. On the other hand, the worker LW2 has not yet finished the work on the vehicle 100b, and a further work delay occurs.

Here, in the lower part of FIG. 2, the worker LW2 reaches the delay notification device DN2, and thus presses the delay notification device DN2. Therefore, as described above, the traveling controller 208 of the server 200 further reduces the speeds of the vehicles 100a, 100b, 100c, and 100d to ½ (that is, ¼ of the original speed) while the predetermined interval is maintained.

As described above, in the vehicle control system 50 according to the present embodiment, in a case where a work delay occurs in any of the vehicles on the work line, the speeds of the vehicles are reduced while the predetermined interval is maintained. Therefore, even in a case where the work delay occurs, all vehicles on the work line do not need to be stopped, and the decrease in work efficiency can be suppressed.

### Modification of First Embodiment

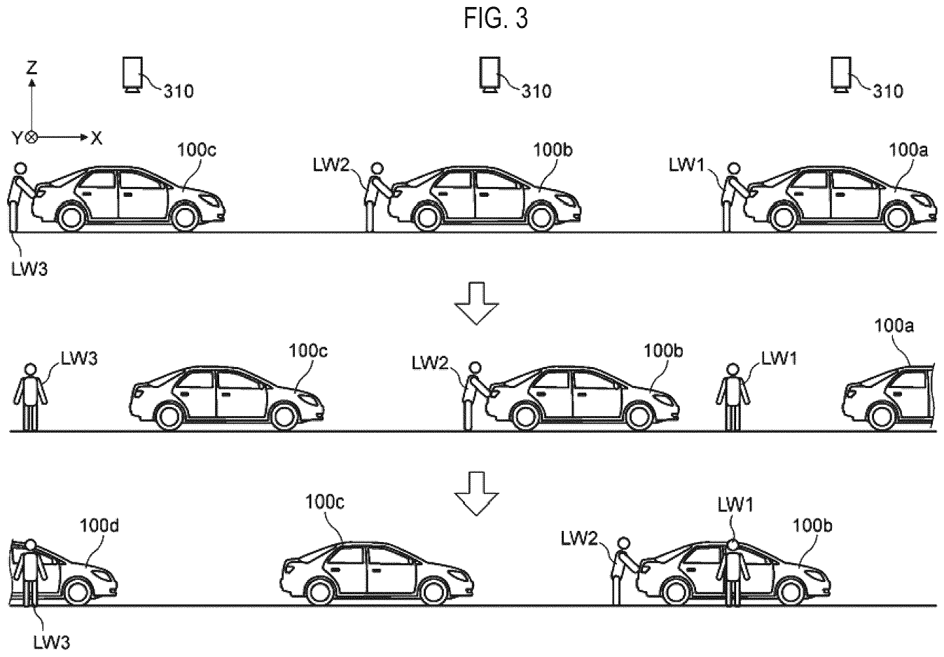

Next, details of the work line to which the vehicle control system according to a modification of the present embodiment is applied will be described with reference to FIG. 3. FIG. 3 is a side view schematically showing a work line on which a vehicle autonomously moves in the vehicle control system according to the modification of the first embodiment. FIG. 3 is a diagram corresponding to FIG. 2.

First, in the work line shown in the upper part of FIG. 3, each of the workers LW1, LW2, and LW3 performs work while each of the workers LW1, LW2, and LW3 moves together with the autonomously moved vehicles 100a, 100b, and 100c. Here, each of the workers LW1, LW2, and LW3 performs work on the vehicles 100a, 100b, and 100c that autonomously drive in a predetermined assigned area on the work line.

Here, in the work line shown in FIG. 3, the delay notification devices DN1 and DN2 that are installed for each of the assigned areas of the workers LW1, LW2, and LW3 in FIG. 2 are not installed. In the work line shown in FIG. 3, the traveling controller 208 of the server 200 detects the work delay from the positions and the like of the workers LW1, LW2, and LW3 and the work target vehicles 100a, 100b, and 100c in the image captured by the camera 310.

Specifically, in a case where it is determined from the image captured by the camera 310 that the worker is still working on the work target vehicle at a predetermined reference position of the work line shown in FIG. 3, the work delay is detected. An example of the predetermined reference position of the work line shown in FIG. 3 here is the installation position of the delay notification device DN1 shown in FIG. 2. In that case, for example, the speeds of the vehicles 100 are reduced to ½.

Further, in a case where it is determined from the image captured by the camera 310 that the worker is still working on the work target vehicle at a predetermined reference position of the work line shown in FIG. 3, a further work delay is detected. An example of the predetermined reference position of the work line shown in FIG. 3 here is the installation position of the delay notification device DN2 shown in FIG. 2. In that case, for example, the speeds of the vehicles 100 are further reduced to ½ (that is, ¼ of the original speed).

Next, in the work line shown in the middle part of FIG. 3, each of the workers LW1 and LW3 finishes the work on the vehicles 100a and 100c, and waits for the next vehicles 100b and 100d. On the other hand, the worker LW2 does not finish the work on the vehicle 100b, and a work delay occurs.

Here, in the middle part of FIG. 3, the worker LW2 reaches the installation position of the delay notification device DN1 shown in FIG. 2 together with the vehicle 100b. In this case, the traveling controller 208 of the server 200 determines that the worker LW2 is still working on the vehicle 100b from the positions and the like of the worker LW2 and the work target vehicle 100b in the image captured by the camera 310, and detects the work delay. In that case, as described above, the traveling controller 208 reduces the speeds of the vehicles 100a, 100b, 100c, and 100d to ½ while the predetermined interval is maintained.

Next, in the work line shown in the lower part of FIG. 3, the workers LW1 and LW3 continue to wait for the next vehicles 100b and 100d. On the other hand, the worker LW2 has not yet finished the work on the vehicle 100b, and a further work delay occurs.

Here, in the lower part of FIG. 3, the worker LW2 reaches the installation position of the delay notification device DN2 shown in FIG. 2 together with the vehicle 100b. In this case, the traveling controller 208 of the server 200 determines that the worker LW2 is still working on the vehicle 100b from the positions and the like of the worker LW2 and the work target vehicle 100b in the image captured by the camera 310, and detects a further work delay. In that case, as described above, the traveling controller 208 further reduces the speeds of the vehicles 100a, 100b, 100c, and 100d to ½ (that is, ¼ of the original speed) while the predetermined interval is maintained.

As described above, in the vehicle control system 50 according to the modification of the present embodiment, in a case where a work delay occurs in any of the vehicles on the work line, the speeds of the vehicles are reduced while the predetermined interval is maintained. Therefore, even in a case where the work delay occurs, all vehicles on the work line do not need to be stopped, and the decrease in work efficiency can be suppressed.

In addition, in the vehicle control system 50 according to the modification shown in FIG. 3, the delay notification devices DN1 and DN2 that are installed for each of the assigned areas of the workers in FIG. 2 are not needed. Therefore, the vehicle control system 50 can be realized with a simpler configuration and can be reduced in cost.

Hereinafter, a traveling control example for controlling the traveling of the vehicle 100 in the system 50 will be described.

### A. Traveling Control Example 1

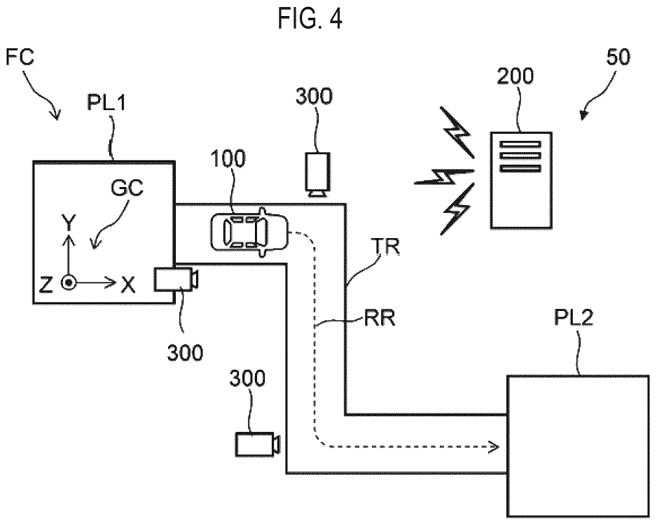

FIG. 4 is a conceptual diagram showing a configuration of the system 50 in traveling control example 1. The system 50 includes one or more vehicles 100 as a mobile object, the server 200, and one or more external sensors 300.

In a case where the mobile object is not a vehicle, the expressions “vehicle” and “car” in the present disclosure can be appropriately replaced with “mobile object”, and the expression “traveling” can be appropriately replaced with “moving”.

The vehicle 100 is configured to travel via unmanned driving. The “unmanned driving” means driving that does not depend on a traveling operation of a passenger. The traveling operation means an operation related to at least any one of “traveling”, “turning”, and “stopping” of the vehicle 100. The unmanned driving is implemented by automatic or manual remote control using a device located outside the vehicle 100 or by autonomous control of the vehicle 100.

The passenger who does not perform the traveling operation may get on the vehicle 100 that travels via the unmanned driving. Examples of the passenger who does not perform the traveling operation include a person who simply sits on a seat of the vehicle 100 and a person who performs work different from the traveling operation, such as assembly, inspection, or operation of switches, in a state of getting on the vehicle 100. The driving by the traveling operation of the passenger can be referred to as “driver-driven”.

In the present specification, the “remote control” includes “complete remote control” in which all the operations of the vehicle 100 are completely decided from the outside of the vehicle 100, and “partial remote control” in which a part of the operations of the vehicle 100 are decided from the outside of the vehicle 100. In addition, the “autonomous control” includes “complete autonomous control” and “partial autonomous control”. In the complete autonomous control, the vehicle 100 autonomously controls its own operation without receiving any information from a device outside the vehicle 100. In the partial autonomous control, the vehicle 100 autonomously controls its own operation using information received from a device outside the vehicle 100.

In the present embodiment, the system 50 is used in a factory FC that manufactures the vehicle 100. A reference coordinate system of the factory FC is a global coordinate system GC. That is, any position in the factory FC is represented by coordinates of X, Y, and Z in the global coordinate system GC. The factory FC includes a first place PL1 and a second place PL2. The first place PL1 and the second place PL2 are connected by a track TR on which the vehicle 100 can travel. A plurality of external sensors 300 is installed in the factory FC along the track TR. A position of each external sensor 300 in the factory FC is adjusted in advance. The vehicle 100 moves via the unmanned driving from the first place PL1 to the second place PL2 along the track TR.

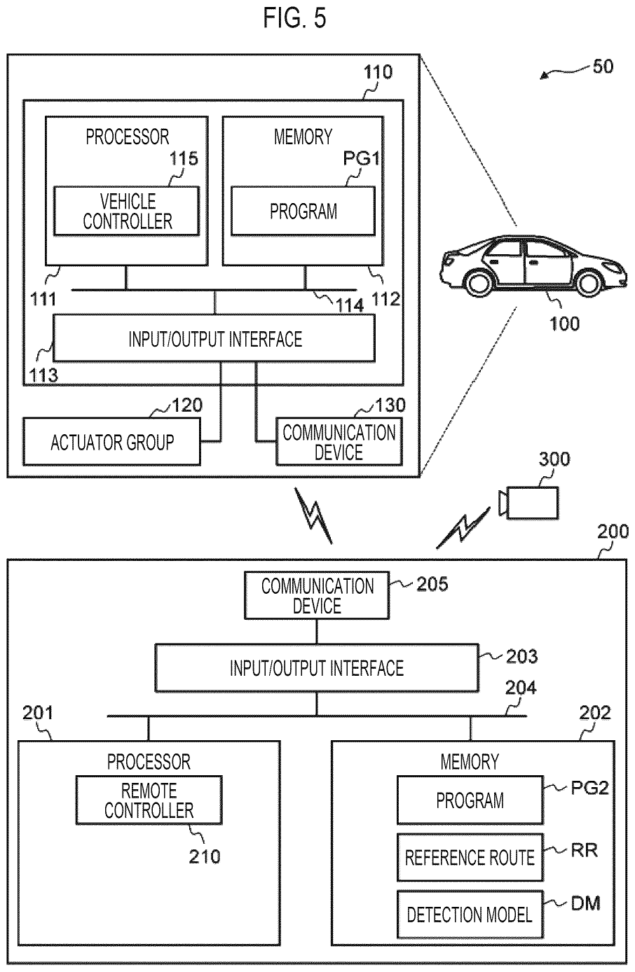

FIG. 5 is a block diagram showing the configuration of the system 50. The vehicle 100 includes a vehicle control device 110, an actuator group 120, and a communication device 130. The vehicle control device 110 is configured to control each part of the vehicle 100. The actuator group 120 includes one or more actuators that are driven under the control of the vehicle control device 110. The communication device 130 is configured to communicate with an external device, such as the server 200 by wireless communication. The actuator group 120 includes an actuator of a drive device for accelerating the vehicle 100, an actuator of a steering device for changing a traveling direction of the vehicle 100, and an actuator of a braking device for decelerating the vehicle 100.

The vehicle control device 110 is configured by a computer including a processor 111, a memory 112, an input/output interface 113, and an internal bus 114. The processor 111, the memory 112, and the input/output interface 113 are connected to be bidirectionally communicable with each other via the internal bus 114. The actuator group 120 and the communication device 130 are connected to the input/output interface 113. The processor 111 executes a program PG1 stored in the memory 112 to implement various functions including functions as a vehicle controller 115.

The vehicle controller 115 controls the actuator group 120 to cause the vehicle 100 to travel. The vehicle controller 115 controls the actuator group 120 using a traveling control signal received from the server 200 to cause the vehicle 100 to travel. The traveling control signal is a control signal for causing the vehicle 100 to travel. In the present embodiment, the traveling control signal includes the acceleration and a steering angle of the vehicle 100 as parameters. In other embodiments, the traveling control signal may include a speed of the vehicle 100 as the parameter instead of or in addition to the acceleration of the vehicle 100.

The server 200 is configured by a computer including a processor 201, a memory 202, an input/output interface 203, and an internal bus 204. The processor 201, the memory 202, and the input/output interface 203 are connected to be bidirectionally communicable with each other via the internal bus 204. The communication device 205 for communicating with various devices outside the server 200 is connected to the input/output interface 203. The communication device 205 can communicate with the vehicle 100 by wireless communication and can communicate with each external sensor 300 by wired communication or wireless communication. The processor 201 implements various functions including a function as a remote controller 210 by executing a program PG2 stored in the memory 202.

The remote controller 210 acquires the detection result by the sensor, and generates the traveling control signal for controlling the actuator group 120 of the vehicle 100 by using the detection result. The remote controller 210 transmits the traveling control signal to the vehicle 100 to cause the vehicle 100 to travel by the remote control. That is, the remote controller 210 includes functions of the position estimation unit 207 and the traveling controller 208 shown in FIG. 1.

In addition, the remote controller 210 may generate and output a control signal for controlling the actuator in addition to the traveling control signal. Examples of the actuator include actuators that operate various auxiliary equipment provided in the vehicle 100 and various equipment, such as a wiper, a power window, and a lamp. That is, the remote controller 210 may operate the various kinds of equipment or the various accessories via the remote control.

The external sensor 300 is a sensor located outside the vehicle 100. The external sensor 300 according to the present embodiment is a sensor that captures the vehicle 100 from the outside of the vehicle 100. The external sensor 300 includes a communication device (not shown) and can communicate with another device, such as the server 200 by wired communication or wireless communication.

Specifically, the external sensor 300 is configured by a camera. The camera as the external sensor 300 captures a captured image including the vehicle 100 and outputs the captured image as a detection result.

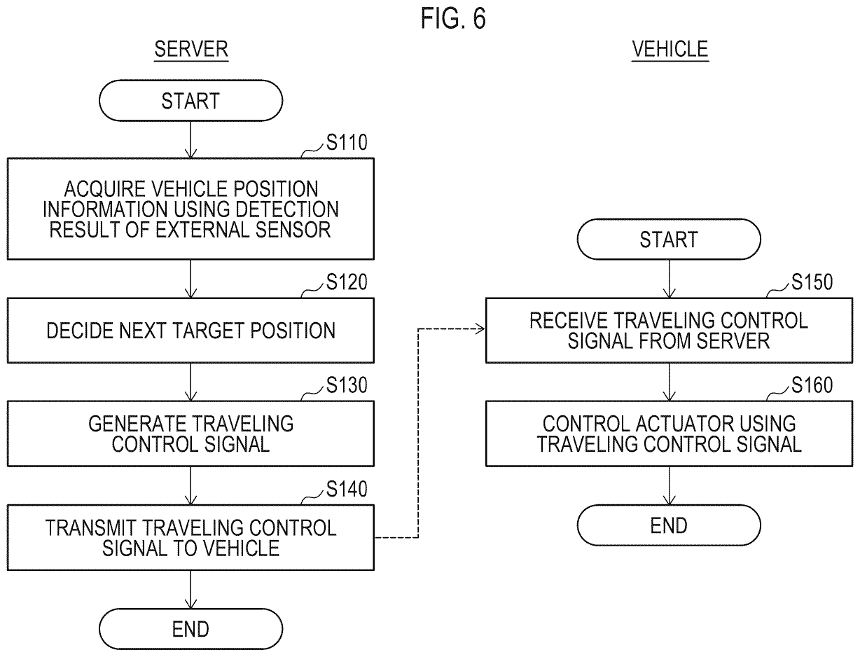

FIG. 6 is a flowchart showing a processing procedure of traveling control of the vehicle 100 in the traveling control example. In the processing procedure of FIG. 6, the processor 201 of the server 200 executes the program PG2 to function as the remote controller 210. In addition, the processor 111 of the vehicle 100 executes the program PG1 to function as the vehicle controller 115.

In step S110, the processor 201 of the server 200 acquires the vehicle position information of the vehicle 100 by using the detection result output from the external sensor 300. The vehicle position information is position information that is a basis for generating the traveling control signal. In the present embodiment, the vehicle position information includes the position and the direction of the vehicle 100 in the global coordinate system GC of the factory FC. Specifically, in step S110, the processor 201 acquires the vehicle position information by using the captured image acquired from the camera as the external sensor 300.

Specifically, in S110, the processor 201 (as a functional block, the position estimation unit 207 shown in FIG. 1) detects, for example, an outline of the vehicle 100 from the captured image. In S110, coordinates of a positioning point of the vehicle 100 in a coordinate system of the captured image, that is, a local coordinate system are calculated, and the calculated coordinates are converted into coordinates in the global coordinate system GC to acquire the position of the vehicle 100.

The outer shape of the vehicle 100 included in the captured image can be detected, for example, by inputting the captured image to a detection model DM using artificial intelligence. The detection model DM is prepared, for example, inside the system 50 or outside the system 50, and is stored in advance in the memory 202 of the server 200. Examples of the detection model DM include a trained machine learning model that has been trained such that any one of semantic segmentation and instance segmentation is implemented. As the machine learning model, for example, a convolutional neural network (CNN) that has been trained by supervised learning using a training data set can be used.

The training data set has, for example, a plurality of training images including the vehicle 100 and a label indicating whether each area in the training image is an area indicating the vehicle 100 or an area indicating an area other than the vehicle 100. When the CNN is trained, it is preferable that parameters of the CNN are updated such that an error between an output result of the detection model DM and the label is reduced by backpropagation (error backpropagation method). In addition, the processor 201 can acquire the orientation of the vehicle 100, for example, by using an optical flow method. In the optical flow method, the orientation of the vehicle 100 is acquired by estimation based on a movement vector of the vehicle 100 calculated from a change in position of a feature point of the vehicle 100 between frames of the captured image.

In step S120, the processor 201 of the server 200 decides the target position to which the vehicle 100 should go next. In the present embodiment, the target position is represented by the coordinates of X, Y, and Z in the global coordinate system GC. The reference route RR that is a route along which the vehicle 100 should travel is stored in advance in the memory 202 of the server 200. The route is represented by a node indicating a departure point, a node indicating a passing point, a node indicating a destination, and a link connecting each of the nodes. The processor 201 decides the target position to which the vehicle 100 should head next by using the vehicle position information and the reference route RR. The processor 201 decides the target position on the reference route RR ahead of the current position of the vehicle 100.

In step S130, the processor 201 of the server 200 generates the traveling control signal for causing the vehicle 100 to travel toward the decided target position. The processor 201 calculates the traveling speed of the vehicle 100 from the transition of the position of the vehicle 100, and compares the calculated traveling speed with a target speed. As a whole, the processor 201 decides the acceleration such that the vehicle 100 is accelerated when the traveling speed is lower than the target speed, and decides the acceleration such that the vehicle 100 is decelerated when the traveling speed is higher than the target speed. In addition, when the vehicle 100 is positioned on the reference route RR, the processor 201 decides the steering angle and the acceleration such that the vehicle 100 does not deviate from the reference route RR. In a case where the vehicle 100 is not located on the reference route RR, in other words, in a case where the vehicle 100 deviates from the reference route RR, the processor 201 decides the steering angle and the acceleration such that the vehicle 100 returns to the reference route RR.

In step S140, the processor 201 of the server 200 transmits the generated traveling control signal to the vehicle 100. The processor 201 repeatedly executes, at a predetermined cycle, the acquisition of the position of the vehicle 100, the decision of the target position, the generation of the traveling control signal, the transmission of the traveling control signal, and the like.

In step S150, the processor 111 of the vehicle 100 receives the traveling control signal transmitted from the server 200. In step S160, the processor 111 of the vehicle 100 controls the actuator group 120 by using the received traveling control signal, to cause the vehicle 100 to travel at the acceleration and the steering angle represented by the traveling control signal. The processor 111 repeatedly executes, at a predetermined cycle, the reception of the traveling control signal and control of the actuator group 120. With the system 50 in the present embodiment, the vehicle 100 is caused to travel by remote control, and the vehicle 100 is moved without using a transport facility, such as a crane or a conveyor.

### B: Traveling Control Example 2

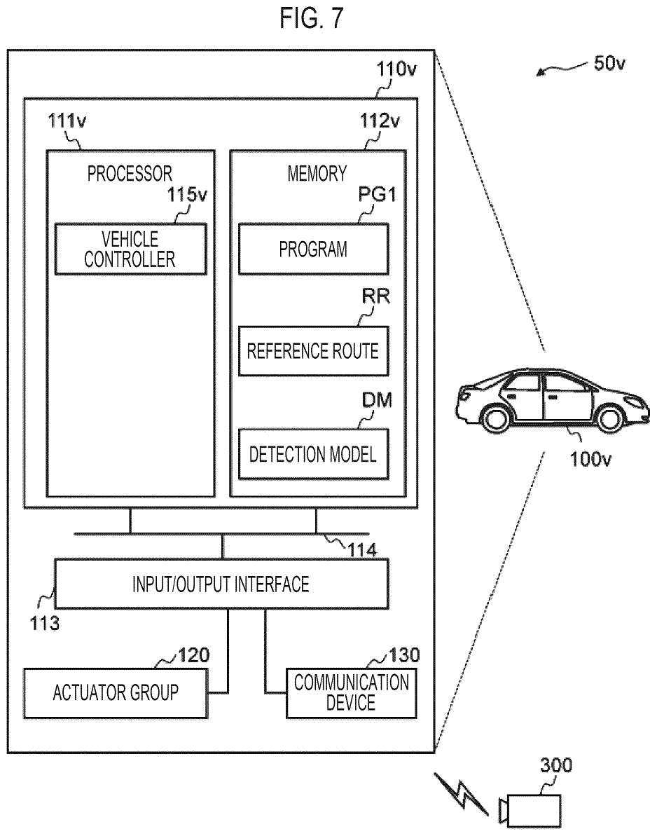

FIG. 7 is a description diagram showing a schematic configuration of a system 50v in the traveling control example 2. In the present embodiment, the system 50v is different from the traveling control example 1 in that the system 50v does not include the server 200. In addition, a vehicle 100v in the configuration can travel by the autonomous control of the vehicle 100v. Other configurations are the same as the configuration described above unless otherwise specified.

In the present embodiment, a processor 111v of a vehicle control device 110v functions as a vehicle controller 115v by executing the program PG1 stored in a memory 112v. The vehicle controller 115v can acquire the output result of the sensor, generate the traveling control signal by using the output result, and output the generated traveling control signal to operate the actuator group 120, thereby causing the vehicle 100v to travel via the autonomous control. In the present embodiment, the detection model DM and the reference route RR are stored in the memory 112v in addition to the program PG1.

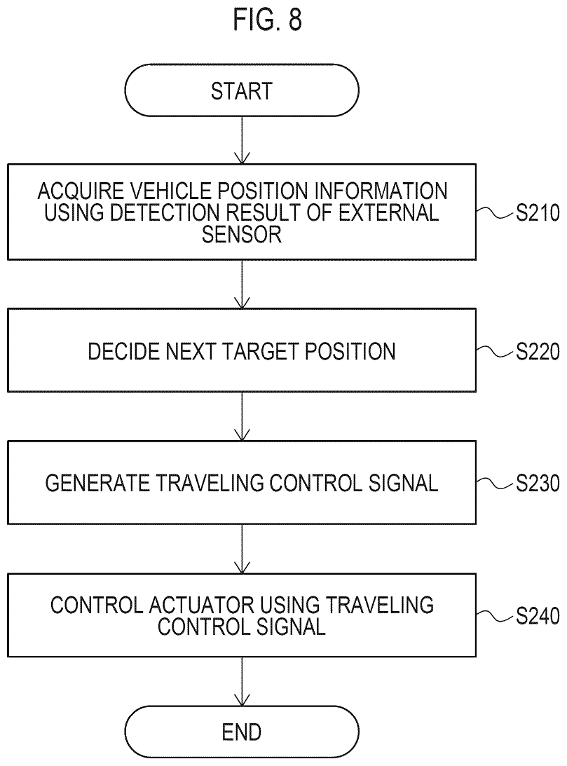

FIG. 8 is a flowchart showing a processing procedure of traveling control of the vehicle 100v in Example 2. In the processing procedure of FIG. 8, the processor 111v of the vehicle 100v executes the program PG1 to function as the vehicle controller 115v.

In step S210, the processor 111v of the vehicle control device 110v acquires the vehicle position information by using the detection result output from the camera that is the external sensor 300.

In step S220, the processor 111v decides the target position to which the vehicle 100v should go next.

In step S230, the processor 111v generates the traveling control signal for causing the vehicle 100v to travel toward the decided target position.

In step S240, the processor 111v controls the actuator group 120 by using the generated traveling control signal, to cause the vehicle 100v to travel in accordance with the parameters represented by the traveling control signal.

The processor 111v repeatedly executes, at a predetermined cycle, the acquisition of the vehicle position information, the decision of the target position, the generation of the traveling control signal, and the control of the actuator. With the system 50v in the present embodiment, the vehicle 100v can travel by autonomous control of the vehicle 100v even without remote control of the vehicle 100v by the server 200.

### YY: Other Traveling Control Example

(YY1) In the example, the external sensor 300 is a camera. However, the external sensor 300 need not be the camera, and may be, for example, a light detection and ranging (LiDAR). In this case, the detection result output by the external sensor 300 may be three-dimensional point cloud data representing the vehicle 100. In this case, the server 200 or the vehicle 100 may acquire the vehicle position information via template matching using the three-dimensional point cloud data as the detection result, and reference point cloud data prepared in advance.

(YY2) In the traveling control example 1, the server 200 executes the processing from the acquisition of the vehicle position information to the generation of the traveling control signal. On the other hand, the vehicle 100 may execute at least a part of the processing from the acquisition of the vehicle position information to the generation of the traveling control signal. For example, the following forms (1) to (3) may be used.

(1) The server 200 may acquire the vehicle position information, decide the target position to which the vehicle 100 should head next, and generate the route from the current position of the vehicle 100 represented by the acquired vehicle position information to the target position. The server 200 may generate a route to the target position between the current position and the destination or may generate a route to the destination. The server 200 may transmit the generated route to the vehicle 100. The vehicle 100 may generate the traveling control signal for causing the vehicle 100 to travel on the route received from the server 200, and control the actuator group 120 by using the generated traveling control signal.

(2) The server 200 may acquire the vehicle position information and transmit the acquired vehicle position information to the vehicle 100. The vehicle 100 may decide the target position to which the vehicle 100 should head next and generate the route from the current position of the vehicle 100 represented by the received vehicle position information to the target position. The vehicle 100 may generate the traveling control signal for causing the vehicle 100 to travel on the generated route, and control the actuator group 120 by using the generated traveling control signal.

(3) In the forms (1) and (2), an internal sensor may be mounted on the vehicle 100, and a detection result output from the internal sensor may be used for at least one of the generation of the route and the generation of the traveling control signal. The internal sensor is a sensor mounted in the vehicle 100. The internal sensor may include, for example, a sensor that detects a motion state of the vehicle 100, a sensor that detects an operation state of each unit of the vehicle 100, or a sensor that detects a surrounding environment of the vehicle 100. Specifically, the internal sensor may include, for example, a camera, a LiDAR, a millimeter wave radar, an ultrasound sensor, a GPS sensor, an acceleration sensor, and a gyro sensor.

For example, in the form (1), the server 200 may acquire the detection result of the internal sensor and reflect the detection result of the internal sensor in the route when the route is generated. In the form (1), the vehicle 100 may acquire the detection result of the internal sensor and reflect the detection result of the internal sensor to the traveling control signal when the traveling control signal is generated. In the form (2), the vehicle 100 may acquire the detection result of the internal sensor and reflect the detection result of the internal sensor to the route when the route is generated. In the form (2), the vehicle 100 may acquire the detection result of the internal sensor and reflect the detection result of the internal sensor to the traveling control signal when the traveling control signal is generated.

(YY3) In the traveling control example 2, the internal sensor may be mounted on the vehicle 100v, and the detection result output from the internal sensor may be used for at least one of the generation of the route and the generation of the traveling control signal. For example, the vehicle 100v may acquire the detection result of the internal sensor and reflect the detection result of the internal sensor to the route when the route is generated. The vehicle 100v may acquire the detection result of the internal sensor and reflect the detection result of the internal sensor to the traveling control signal when the traveling control signal is generated.

(YY4) In the traveling control example 2, the vehicle 100v acquires the vehicle position information by using the detection result of the external sensor 300. On the other hand, an internal sensor may be mounted on the vehicle 100v, and the vehicle 100v may acquire the vehicle position information by using the detection result of the internal sensor. In this case, the target position to which the vehicle 100v is to proceed next is determined, and a route from the current location of the vehicle 100v represented by the acquired vehicle position information to the target position is generated. Then, the traveling control signal for traveling on the generated route is generated, and the actuator group 120 is controlled by using the generated traveling control signal. With such a configuration, the vehicle 100v can travel without using the detection result of the external sensor 300 at all.

The vehicle 100v may acquire a target arrival time or traffic jam information from the outside of the vehicle 100v and reflect the target arrival time or the traffic jam information to at least one of the route and the traveling control signal. In addition, all of the functions of the system 50v may be provided in the vehicle 100v. That is, the processing implemented by the system 50v according to the present disclosure may be implemented by the vehicle 100v alone.

(YY5) In the traveling control example 1, the server 200 automatically generates the traveling control signal to be transmitted to the vehicle 100. On the other hand, the server 200 may generate the traveling control signal to be transmitted to the vehicle 100 in response to an operation of an external operator who is located outside the vehicle 100. For example, the external operator may operate a control device including a display, a steering wheel, an accelerator pedal, a brake pedal, and a communication device. In this case, the server 200 may generate the traveling control signal in accordance with the operation added to the driving device. The display is configured to display the captured image output from the external sensor 300. The steering wheel, the accelerator pedal, and the brake pedal are used to remotely operate the vehicle 100. The communication device is configured to communicate with the server 200 by wired communication or wireless communication.

(YY6) In each of the traveling control examples, the vehicle 100 may be configured to move via the unmanned driving, and may be, for example, a platform having a configuration described below. Specifically, the vehicle 100 need solely include at least the vehicle control device 110 and the actuator group 120, in order to exhibit the three functions of “traveling”, “turning”, and “stopping” via the unmanned driving.

In a case where the vehicle 100 acquires the information from the outside for the unmanned driving, the vehicle 100 need solely further include the communication device 130. That is, the vehicle 100 configured to move via the unmanned driving need not be equipped with at least a part of interior components, such as a driver's seat and a dashboard. The vehicle 100 configured to move via the unmanned driving may not have at least a part of the exterior components, such as the bumper or the fender, and may not have the body shell.

In this case, the vehicle 100 may be equipped with the remaining components, such as the body shell, before the vehicle 100 is shipped from the factory FC. The vehicle 100 may be equipped with the remaining components, such as the body shell, after the vehicle 100 is shipped from the factory FC in a state where the vehicle 100 is not equipped with the remaining components, such as the body shell. Each of the components may be mounted from any direction, such as the upper side, the lower side, the front side, the rear side, the right side, or the left side of the vehicle 100, and may be mounted from the same direction or different directions. The position decision can be made for the form of the platform in the same manner as the vehicle 100 according to the first embodiment.

(YY7) The vehicle 100 may be manufactured by combining a plurality of modules. The module means a unit configured by a plurality of components assembled depending on the part or the function of the vehicle 100. For example, the platform of the vehicle 100 may be manufactured by combining a front module, a center module, and a rear module. The front module constitutes a front portion of the platform. The center module constitutes a center portion of the platform. The rear module constitutes a rear portion of the platform.

In addition, the number of modules constituting the platform is not limited to three, and may be two or less or four or more. In addition to or instead of the components constituting the platform, the components constituting a portion of the vehicle 100 that is different from the platform may be modularized. In addition, various modules may include any exterior component, such as a bumper or a grille, or any interior component, such as a seat or a console.

In addition, the present disclosure is not limited to the vehicle 100, a mobile object of any aspect may be manufactured by combining the modules. Such a module may be manufactured, for example, by joining the components via welding or a fastener, or may be manufactured by integrally molding at least a part of the components constituting the modules as one component via casting. A molding method of integrally molding one component, particularly a relatively large component, is also called giga casting or mega casting. For example, the front module, the center module, and the rear module may be manufactured by using giga casting.

(YY8) The transport of the vehicle 100 using the traveling of the vehicle 100 via the unmanned driving is also referred to as “autonomous transport”. In addition, a configuration for implementing the autonomous transport is also referred to as “vehicle remote control autonomous driving transport system”. Further, a production method of producing the vehicle 100 by using the autonomous transport is also referred to as “autonomous production”. In the autonomous production, for example, at the factory FC that manufactures the vehicle 100, at least a part of the transport of the vehicle 100 is implemented by the autonomous transport.

(YY9) In each of the traveling control examples, a part or all of the functions and the processing that are software-implemented may be hardware-implemented. Further, a part or all of the functions and the processing that are implemented by hardware may be implemented by software. As the hardware for implementing various functions in each of the embodiments, for example, various circuits, such as an integrated circuit or a discrete circuit, may be used.

It should be noted that the present disclosure can implement a part or all of the processing in the external sensor 300, the vehicle 100, the server 200, and the like described above by causing a central processing unit (CPU) to execute a computer program.

The program includes an instruction group (or software code) for causing a computer to execute one or more functions described in the embodiment in a case where the program is read into the computer. The program may be stored on a non-transitory computer-readable medium or a tangible storage medium. As an example, but not limited thereto, the computer-readable medium or the tangible storage medium includes a random-access memory (RAM), a read-only memory (ROM), a flash memory, a solid-state drive (SSD), or other memory technologies, a CD-ROM, a digital versatile disc (DVD), a Blu-ray (registered trademark) disc, or other optical disc storage, a magnetic cassette, a magnetic tape, a magnetic disk storage, or other magnetic storage devices. The program may be transmitted on a transitory computer-readable medium or a communication medium. Examples having no limitation of the transitory computer-readable medium or the communication medium include electrical, optical, acoustic, or other forms of propagated signals.

Although the present disclosure has been described with reference to the embodiments, the present disclosure is not limited to the embodiments. The configurations and details of the present disclosure can be variously changed by those skilled in the art within the scope of the present disclosure. Each embodiment can be appropriately combined with other embodiments.

What is claimed is:

1. A vehicle control system comprising:
a sensor configured to detect position information of a plurality of vehicles traveling; and
a controller configured to control traveling of the vehicles based on the position information acquired from the sensor, wherein:
the vehicles are caused to autonomously move at a predetermined interval on a work line while a worker moves to each of the vehicles to perform work; and
the controller is configured to reduce, in a case where a work delay occurs in any of the vehicles on the work line, speeds of the vehicles while the predetermined interval is maintained.

2. The vehicle control system according to claim 1, wherein the controller is configured to increase an amount of reduction in the speeds as a degree of the work delay increases.

3. The vehicle control system according to claim 1, further comprising a delay notification device configured to enable the worker to perform notification of the work delay,
wherein the controller is configured to reduce the speeds of the vehicles based on information indicating the work delay transmitted from the delay notification device.

4. The vehicle control system according to claim 1, wherein:
the sensor is a camera; and
the controller is configured to detect the work delay from positions of the worker and a work target vehicle in an image captured by the camera and reduce the speeds of the vehicles.
